(19) United States
(12) Patent Application Publication
(10) Pub. No.: US 2009/0228152 A1
(43) Pub. Date: Sep. 10, 2009

(54) Chiller Adaptation for Cold Weather Use

(75) Inventors: Dean B. Anderson, Spring Grove, IL (US); Peter Khalimendik, Lake Villa, IL (US); Michael F. Lynn, Green Oaks, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Building Technologies, Inc., Buffalo Grove, IL (US)

(21) Appl. No.: 12/396,967

(22) Filed: Mar. 3, 2009

Related U.S. Application Data
(60) Provisional application No. 61/033,615, filed on Mar. 4, 2008.

(51) Int. Cl. G05D 7/00; F25B 1/00; F25B 49/00; G05D 23/00

(52) U.S. Cl. 700/282; 62/498; 62/126; 700/299

(57) ABSTRACT

A chiller refrigeration system provides optimum operation of controlled cooling for a building during low ambient temperatures. The chiller refrigeration system includes a second receiver that stores sufficient refrigerant to flood the condenser at low ambient temperatures. The chiller refrigeration system also includes a pressure control valve to selectively bypass pressurized refrigerant gas around the condenser to the second receiver when the ambient air is too cold to sustain continuous compressor operation. The system also includes a check valve to prevent refrigeration from migrating backwards to the low pressure point in the system and a pressure relief valve to serve as a system safety device.

### CROSS REFERENCE OF RELATED APPLICATIONS

This patent claims the priority benefit under 35 U.S.C. §119(e) of U.S. provisional patent application Ser. No. 61/033,615 (2008P0385US01), submitted on Mar. 4, 2008; the content of which is hereby incorporated by reference for all purposes.

### FIELD OF INVENTION

This invention relates to refrigeration systems, in particular, cold water chillers for medical equipment that need to operate at low ambient temperatures.

### BACKGROUND

Industrial chillers are used for controlled cooling of products, mechanisms and factory machinery in a wide range of industries, including the hospital industry, which requires around the clock reliability for equipment operation. During extremely cold temperatures in the winter, several installations experience chiller failures, due to colder than expected North American ambient temperatures. Replacement of chillers is a major expense and undertaking. In general, chillers are expensive devices and when purchased require cranes and other large machinery to lift and situation them into position. Another challenge involving industrial chillers is that complicated wiring and plumbing accompany the installations for chiller operation.

Therefore, there is a need for a less expensive and minimally business impacting solution to modify existing chillers for reliable operation in low ambient temperatures.

### SUMMARY

It is one objective of the invention to provide, a chiller refrigeration system comprising: an evaporator for heating a refrigerant; a compressor for removing vapor from the evaporator; a condenser for dissipating a heat held in the vapor and converting the vapor to a pressurized liquid refrigerant; a head pressure control valve for selectively bypassing the pressurized liquid refrigerant around the condenser back to a first or second receiver for storing the pressurized liquid refrigerant; a check valve for preventing pressurized liquid refrigerant from migrating backwards to a low pressure point; a pressure relief valve for controlling a pressure in a system; and a thermal expansion valve for controlling a rate at which the refrigerant flows to the evaporator.

It is another objective of the invention to provide, a chiller service kit comprising: a second receiver for storing a large volume of a pressurized liquid refrigerant to flood a condenser at all ambient conditions; a head pressure control valve for selectively bypassing pressurized liquid refrigerant around the condenser back to a first or the second receiver; a check valve for preventing pressurized liquid refrigerant from migrating backwards to a low pressure point; and a pressure relief valve for controlling a pressure in a system.

It is another objective of the invention to provide, a method to optimize a chiller refrigeration system, the method comprising steps of: providing a second receiver for storing a large volume of a pressurized liquid refrigerant to flood a condenser at all ambient conditions; selectively bypassing pressurized liquid refrigerant around the condenser to the second receiver using a head pressure control valve during low ambient temperatures; providing a pressure relief valve for controlling pressure in the chiller refrigeration system; and providing a check valve for preventing a refrigerant from migrating backwards to a low pressure point in the chiller refrigeration system.

### BRIEF DESCRIPTION OF DRAWINGS

FIG. 1 shows a schematic diagram of the refrigeration system.

FIG. 2 shows a block diagram of the refrigeration system.

FIG. 3 shows an electrical diagram of the refrigerated parts.

### DETAILED DESCRIPTION

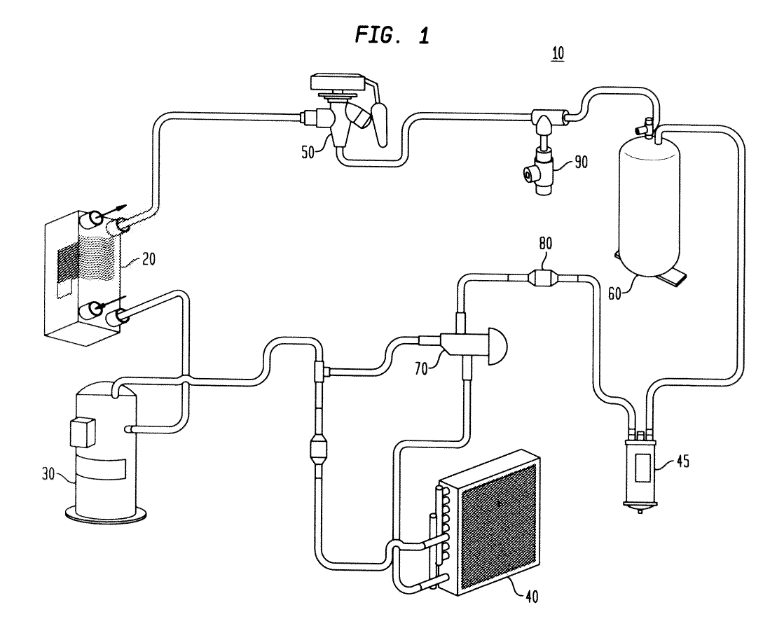

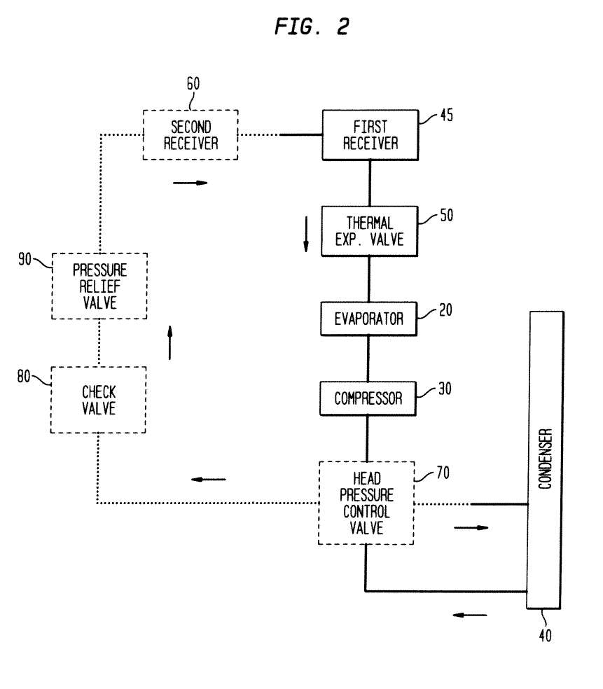

In FIGS. 1 and 2, the refrigeration system 10 comprises the evaporator 20 where the refrigerant R134 or R22 boils or evaporates at a temperature sufficiently low to absorb heat from a space or from a medium that is being cooled. The evaporating temperature is determined, for any given refrigerant, by the pressure maintained in the evaporator 20, therefore, the higher the pressure, the higher the boiling point; the lower the pressure, the lower the boiling point.

The refrigeration system 10 also comprises a compressor 30 that removes vapor from the evaporator 20 as vapor is created. The rate at which vapor is removed is adequately rapid to sustain the desired pressure in the evaporator 20. The vapor is then compressed and transferred to the condenser 40. The condenser 40 dissipates heat held in the hot vaporized refrigerant to a circulating coolant, usually ambient air; however, others skilled in the art may also use water. The refrigerant is condensed to a liquid and is returned to the first receiver 45 and made ready for another refrigeration cycle.

Located before the evaporator 20 is a thermal expansion valve 50 which controls the rate at which liquid refrigerant can flow to the evaporator 20. This is accomplished by use of a temperature sensing device that causes the thermal expansion valve 50 to open or close as temperature changes in the evaporator 20. The thermal expansion valve 50 acutely decreases the pressure of the liquid refrigerant passing through it, thereby substantially reducing the pressure and temperature of the refrigerant in evaporator 20. Once the evaporator 20 reaches the pressure and temperature lower than the medium to be cooled, effective heat transfer begins. Refrigerant leaving the evaporator 20 is in a superheated vapor state and is then pulled by the compressor 30 and discharged to the condenser 40 for another refrigeration cycle to begin.

In the evaporator 20, the vapor compression and expansion refrigeration process as described above depends upon a refrigerant, which absorbs heat at a relatively low temperature. In the condenser 40, by action of mechanical work of the compressor 30, the refrigerant is compressed and raised to an adequately high temperature to permit the dissipation of this heat to the surrounding ambient air. Therefore, the refrigeration system 10 uses the refrigerant as a heat transfer fluid that absorbs heat from the medium that is to be cooled, and releases the recovered heat in another location.

Refrigeration system 10 also comprises a second receiver 60 located before the evaporator 20 and compressor 30. The second receiver 60 is approximately three times larger in volume than the first receiver 45 (shown in FIG. 2). The second receiver 60 is sized large enough to equal the volume of the condensor 40 and associated piping. Sufficient refrigerant is then available to flood condensor 40 under all ambient conditions, in particular, extremely low ambient temperatures. The second receiver 60 is heated and insulated to maintain a temperature and pressure, which will allow normal chiller operation at low ambient temperatures. The second receiver 60 insures that there is always a ready supply of liquid refrigerant available for the compressor 30 to work on and run at start up. The refrigeration system 10 also comprises a pressure controlled valve 70 to selectively bypass pressurized refrigerant gas around the condenser 40 back to the second receiver 60 when the ambient air is too cold to sustain continuous compressor 30 operation. In cold ambient temperatures refrigerant migrates to the coldest or lowest pressure point in the system, i.e. condenser 40, which is exposed to ambient air. Pressure control valve 70 bypasses refrigerant to the second receiver 60 and makes it available to run the refrigeration cycle and maintain overall liquid refrigerant pressures in the refrigeration system 10 under cold ambient conditions.

The refrigeration system 10 also comprises check valve 80. Check valve 80 prevents refrigerant from migrating backwards to the low pressure point in the system. The refrigeration system 10 also comprises a pressure relief valve 90 which serves as system safety device.

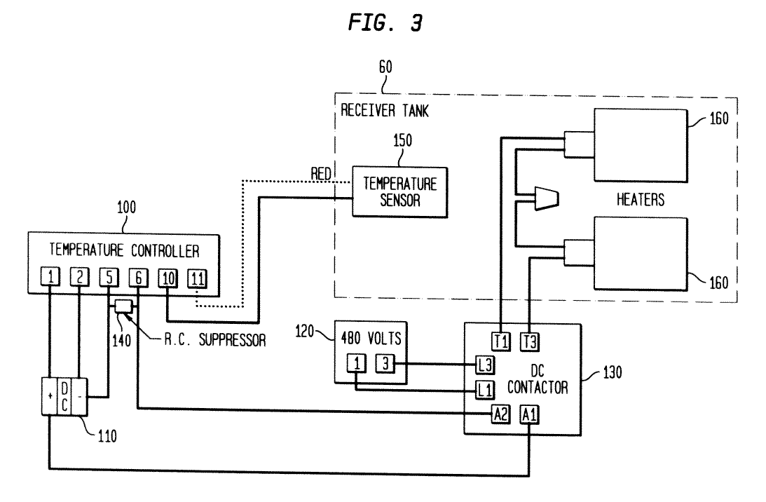

In FIG. 3, components of the refrigeration system 10 are shown in electrical configuration. An additional temperature controller 100 and DC contactor 130 are added to the refrigeration system 10 to regulate temperature of the second receiver 60. The second receiver 60 is equipped with a temperature sensor 150 which relays sensed temperature to the temperature controller 100. After processing the input received from the temperature sensor 150, the temperature controller 100 then sends a signal to the DC contactor 130. The blanket heaters 160 are then activated or alternatively disengaged to maintain pre-set temperature and pressure points. An AC power supply 120 supplies power to the DC contactor 130 and the temperature controller 100 is powered by a DC power supply 110. R.C suppressor 140 suppresses any inductive spikes that may be created across the temperature controller 100 when active. Instructions will be provided to correctly install the second heated receiver tank 60, pressure control valve 70, check valve 80, and pressure relief valve 90 and other necessary devices to make the refrigeration system 10 function properly. The instructions also cover other related maintenance items that are required to enable a chiller system to provide peek performance at extreme low ambient temperatures.

While the foregoing description and drawings represent the preferred embodiments of the present invention, it will be apparent to those skilled in the art that various changes and modifications may be made therein without departing from the true spirit and scope of the present invention.

1-6. (canceled)

7. A chiller apparatus configured for use with a refrigeration system, the chiller apparatus comprising:
a refrigeration system comprising:
an evaporator configured to heat a liquid refrigerant to a vapor;
a compressor fluidly coupled to the evaporator and configured to remove the heated vapor from the evaporator; and
a condenser fluidly coupled to the compressor and configured to dissipate the heat stored within the heated vapor and provide a pressurized liquid refrigerant;
a control valve fluidly coupled to the compressor and configured to selectively route the pressurized liquid refrigerant around the condenser to a receiver, wherein the receiver is configured to store the pressurized liquid refrigerant;
a check valve fluidly coupled between the control valve and the receiver and configured to prevent a flow of the pressurized liquid refrigerant to a low pressure point;
a pressure relief valve fluidly coupled to the receiver, the pressure relief value configured to control a system pressure associated with the pressurized liquid refrigerant; and
a thermal expansion valve fluidly coupled to the pressure relief valve and the evaporator.

8. The apparatus of claim 7, wherein the receiver includes a first receiver and a second receiver and wherein the second receiver provides a larger storage volume than the first receiver.

9. The apparatus of claim 8, wherein a storage volume of the second receiver is approximately three times the storage volume of the first receiver.

10. The apparatus of claim 9 further comprising at least one blanket heater for maintaining a pre-set temperature and a pre-set pressure point in the second receiver.

11. The apparatus of claim 7 further comprising at least one blanket heater for maintaining a pre-set temperature and a pre-set pressure point in the receiver.

12. The apparatus of claim 7 further comprising a temperature sensor for relaying a signal to a temperature controller, wherein the temperature controller is configured to maintain a pre-set temperature and a pre-set pressure point in the receiver.

13. The apparatus of claim 7 further comprising a tank wherein a volume of the tank corresponds to the condenser and an associated piping.

14. A chiller service kit comprising:
a receiver configured to store a volume of a pressurized liquid refrigerant at least equal to a second volume of pressurized liquid refrigerant necessary to flood a condenser at all ambient conditions;
a control valve in fluid communication with the condenser and the receiver, wherein the control valve is configured to selectively route pressurized liquid refrigerant away from the condenser and to the receiver based on one or more ambient conditions;
a check valve in fluid communication between the control valve and the receiver and configured to prevent a flow of the pressurized liquid refrigerant to a low pressure point;
a pressure relief valve in fluid communication with the receiver, the pressure relief value configured to control a system pressure associated with the pressurized liquid refrigerant.

15. The chiller service kit of claim 14, wherein the receiver includes a first receiver and a second receiver and wherein the second receiver provides a larger storage volume than the first receiver.

16. The chiller service kit of claim 15, wherein a storage volume of the second receiver is approximately three times the storage volume of the first receiver.

17. The chiller service kit of claim 16 further comprising at least one blanket heater for maintaining a pre-set temperature and a pre-set pressure point in the second receiver.

18. The chiller service kit of claim 14 further comprising at least one blanket heater for maintaining a pre-set temperature and a pre-set pressure point in the receiver.

19. The chiller service kit of claim 14 further comprising a temperature sensor for relaying a signal to a temperature controller, wherein the temperature controller is configured to maintain a pre-set temperature and a pre-set pressure point in the receiver.

20. The chiller service kit of claim 14 further comprising a tank wherein a volume of the tank corresponds to the condenser and an associated piping.

21. A method to optimize a chiller refrigeration system, the method comprising steps of:
providing a receiver configured to store a volume of a pressurized liquid refrigerant at least equal to a second volume of pressurized liquid refrigerant necessary to flood a condenser at all ambient conditions;
selectively routing pressurized liquid refrigerant away from the condenser and to the receiver based on one or more ambient conditions utilizing a control valve in fluid communication with the condenser and the receiver;
preventing a flow of the pressurized liquid refrigerant to a low pressure point utilizing a check valve in fluid communication between the control valve and the receiver;
controlling a system pressure associated with the pressurized liquid refrigerant utilizing a pressure relief valve in fluid communication with the receiver.
